(19) United States
(12) Patent Application Publication
(10) Pub. No.: US 2015/0324826 A1
(43) Pub. Date: Nov. 12, 2015

(54) SERVER DEVICE, SOFTWARE PROGRAM, AND SYSTEM

(71) Applicant: DeNA Co., Ltd., Tokyo (JP)

(72) Inventor: Sota MIZUSHIMA, Tokyo (JP)

(21) Appl. No.: 14/706,478

(22) Filed: May 7, 2015

(30) Foreign Application Priority Data
May 9, 2014 (JP) 2014-097255

(51) Int. Cl. G06Q 30/02; G06Q 50/00

(52) U.S. Cl. CPC G06Q 30/0214; G06Q 50/01

(57) ABSTRACT

A server 10 providing predetermined services to user terminals over a network is equipped with: an invitation processing module 15 that configures invitation content information in response to an invitation request from the terminal of an invitor user of above-described service, and a benefit-providing module 17 that compares content information uploaded from the terminal of the invitee user with content information configured in the above-described invitation processing module 15 when the invitee user invited by the above-described invitor user registers with the service, and awards benefits to the above-described invitor user and/or the above-described invitee user based on the result of this comparison.

The present application claims the benefit of Japanese Patent Application No. JP2014-097255, filed on May 9, 2014, the contents of which is incorporated herein in its entirety by reference.

### BACKGROUND

1. Technical Field

The present invention relates to a server device, a software program (e.g., non-transitory computer readable media having machine-executable instructions to operate a computer having a storage and a hardware processor connected via a network to a terminal device), and a system that provide gaming and other services, for example, over a network.

2. Background Art

Network-enabled game services allowing multiple users to participate over a network have proliferated in recent years. Communication with a server device belonging to a game operator using PC (Personal Computer) terminals, mobile terminals, and other information processing devices makes it possible to engage in communication with other users or cooperate with them to play a game.

In such game services, there is a mechanism for new user acquisition whereby an invitation ID code (invitation ID) is transmitted to a user terminal from a game operator's server device, and when the user receiving the invitation ID enters the invitation ID on the registration screen of a game application, or the like, the user is awarded in-game currency, gifts, and other incentives. For example, Patent Citation 1 discloses a technique in which a user befriended in one game is invited to play a different game, and a buddy relationship is easily established in the other game.

### PRIOR-ART DOCUMENT

### Patent Document

### [Patent Document 1]

Japanese Patent Application Publication No. 2013-225290

### Problems to be Solved by the Invention

However, when registration is performed using the above-mentioned invitation ID, users must manually enter the text used as the invitation ID on a registration screen, or must alternate between the receipt screen for the invitation ID and the registration screen, and many users give up on registration as a result. In addition, if text data is used for the invitation ID, there is a risk that the data may be analyzed by malicious parties, particularly when there is concern about leakage of such data.

### SUMMARY

The present invention has been devised by taking such problems into consideration and it is an object of the invention to provide a server device, a software program (e.g., non-transitory computer readable media having machine-executable instructions to operate a computer having a storage and a hardware processor connected via a network to a terminal device), and a system allowing for registration to be performed in a simple, easy, and safe manner without requiring laborious input operations.

### Means for Solving the Problems

A first aspect of the present invention provides: a server device that provides a predetermined service to a user terminal over a network, wherein said server device has an invitation processing module that configures invitation content information in response to an invitation request from a terminal of an invitor user of the above-mentioned service, and a benefit-providing module that compares content information uploaded from an invitee user's terminal with content information configured by the above-mentioned invitation processing module when the invitee user invited by the above-mentioned invitor user registers with the service, and awards benefits to the above-mentioned invitor user and/or the above-mentioned invitee user based on the result of this comparison; a software program (e.g., non-transitory computer readable media having machine-executable instructions to operate a computer having a storage and a hardware processor connected via a network to a terminal device) that corresponds to this server device; and a system that utilizes this server device.

The above-mentioned first aspect allows for registration to be completed in a simple, easy, and safe manner because it does not require laborious input operations and, in addition, there is not much danger of a third party viewing images or other invitation content information. Namely, since the registration procedure can be completed simply by selecting and uploading invitation content information, the manual entry of invitation IDs can be done away with, thereby allowing simple and easy registration. In addition, the use of content information, for example, image data, instead of invitation IDs makes it more difficult to generate identical images and thus allows for an improvement in security. By awarding benefits to invitor users and invitee users, invitations to the service become more lively and an increase in the number of users subscribing to the service can be achieved.

In a second aspect of the present invention, the above-mentioned benefit-providing module presents a registration screen including an upload button to the terminal of the above-mentioned invitee user.

In accordance with the above-mentioned second aspect, the invitee user can complete the registration procedure simply by pushing the upload button on the registration screen and selecting invitation content information. This makes it possible to do away with the manual entry of invitation IDs and allows for simple and easy registration.

In a third aspect of the present invention, the above-mentioned invitation processing module configures content information held in the terminal of the above-mentioned invitor user as the above-mentioned invitation content information.

In accordance with the above-mentioned third aspect, using images and other content information belonging to the invitor user as the invitation content information makes it easier to invite the invitee user to the service.

In a fourth aspect of the present invention, the above-mentioned benefit-providing module compares the binary data of the content information uploaded from the terminal of the above-mentioned invitee user with that of the invitation content information configured by the above-mentioned invitation processing module.

In accordance with the above-mentioned fourth aspect, the comparison of the binary data ensures a correct determination as to whether or not the image data is identical and makes it possible to distinguish invitation images, and so forth, that have undergone processing.

In a fifth aspect of the present invention, the above-mentioned benefit-providing module compares the hash values of the content information uploaded from the terminal of the above-mentioned invitee user with those of the content information configured by the above-mentioned invitation processing module.

In accordance with the above-mentioned fifth aspect, security can be enhanced because it is difficult to forge content information having the same hash values.

In a sixth aspect of the present invention, the above-mentioned content information is an image including an ID code obtained by converting predetermined information, and

the above-mentioned benefit-providing module compares information read from the above-mentioned content information uploaded from the terminal of the invitee user with information read from the content information configured by the above-mentioned invitation processing module.

In accordance with the above-mentioned sixth aspect, the incorporation of predetermined information into an ID code, such as a bar-code, a two-dimensional code, or the like, facilitates image comparison.

It should be noted that any combinations of the above-mentioned constituent elements and aspects, as well as subject matter produced by converting the wording of this invention to methods, apparatus, systems, computer programs, and the like, are valid as aspects of the present invention.

### Effects of the Invention

The present invention can provide a server device, a software program (e.g., non-transitory computer readable media having machine-executable instructions to operate a computer having a storage and a hardware processor connected via a network to a terminal device), and a system that allow for registration to be completed in a simple, easy, and safe manner, without requiring laborious input operations.

### BRIEF DESCRIPTION OF THE DRAWINGS

FIG. 1

A diagram illustrating an exemplary configuration of the system according to Embodiment 1.

FIG. 2

A diagram illustrating an exemplary configuration of the mobile terminals or PC terminal of FIG. 1.

FIG. 3

A diagram illustrating an exemplary configuration of the server of FIG. 1.

FIG. 4

A diagram depicting an example of the user information table of FIG. 3.

FIG. 5

A diagram depicting an example of the invitation information table of FIG. 3.

FIG. 6

A sequence diagram illustrating an exemplary processing procedure of the system of FIG. 1.

FIG. 7A

A diagram illustrating an exemplary user registration screen of the user terminal of FIG.

FIG. 7B

A diagram depicting an example of an invitation image registration screen of the user terminal of FIG. 1.

FIG. 8

A sequence diagram depicting an exemplary processing procedure of the system according to Embodiment 2.

### DETAILED DESCRIPTION

### Embodiment 1

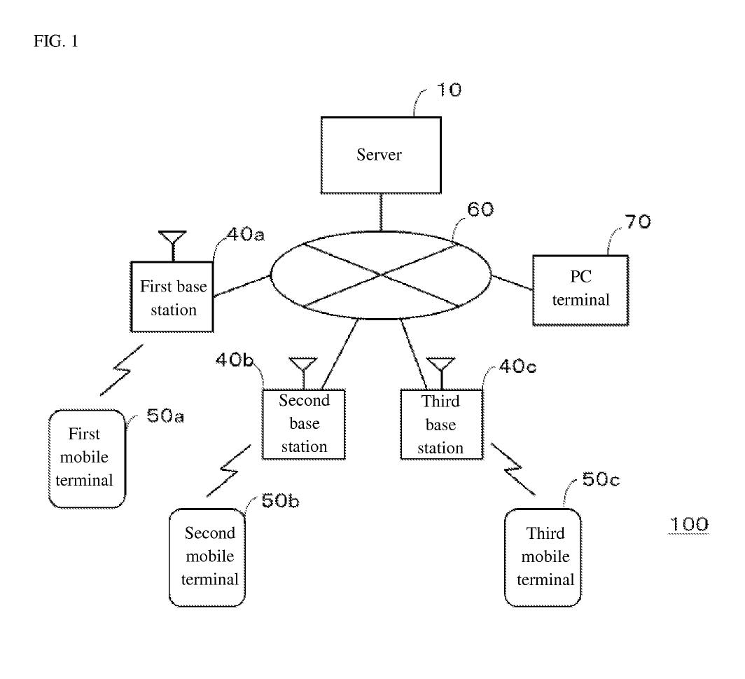

FIG. 1 is a diagram illustrating a system 100 according to Embodiment 1 of the present invention. The system 100 includes: a server 10, a network 60, which connects the server 10 and base stations 40 through wired connections, first base station 40a through third base station 40c, which are represented as base stations 40; first mobile terminal 50a through third mobile terminal 50c, which are represented as mobile terminals 50, and a PC terminal 70. The mobile terminals 50 include, for example, a feature phone, a smartphone, a tablet computer terminal, or the like.

In this system 100, predetermined services are provided by the server 10 to the PC terminal 70 through the network 60, or to the mobile terminals 50 through the network 60 and the base stations 40. These services include, for instance, game services provided via SNS (Social Networking Service), or services utilizing game applications downloaded to the terminals from an application-providing platform. The application-providing platform may be integrated with the server 10 or provided separately.

In order to ensure that the number of users registering with these services increases, this system 100 possesses functionality such that users registered with the service (invitor users) invite unregistered users (invitee users). Such invitations are extended by the invitor users to the invitee users by sending an invitation message containing the hereinafter-described invitation content information by e-mail or the like. When the invitee users register with the service and the invitation content information is registered, the invitor users and/or the invitee users can be awarded benefits that can be used in this service.

Although in the discussion below an invitation image is used as the invitation content information, quite naturally, such information is not limited to images and it will have similar action and effects even if it includes audio, video, and other binary data. It should be noted that an improvement in security can also be obtained when using image content because it is believed that completely identical images are difficult to generate by means other than copying.

It should be noted that, in FIG. 1, while only three base stations 40 and mobile terminals 50 are depicted in the drawing for the convenience of illustration, this need not be the case, and there may be more base stations 40 and mobile terminals 50. The same applies to the PC terminal 70. In addition, while the mobile terminals (i.e. first mobile terminal 50a through third mobile terminal 50c) are illustrated as connected to respectively different base stations 40, this need not be the case, and it goes without saying that the present invention is applicable even if multiple mobile terminals 50 are connected to a single base station 40. In addition, the base stations 40 may constitute access points, such as a wireless LAN, or the like. Below, the mobile terminals 50 and the PC terminal 70 are collectively referred to as “user terminals”.

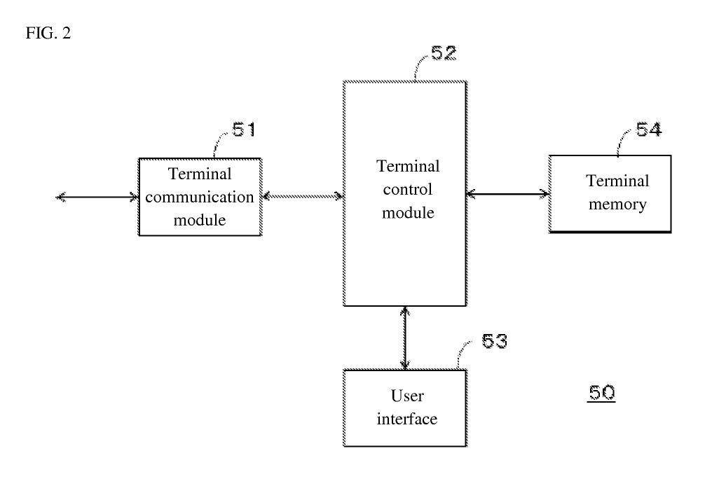

FIG. 2 is a diagram illustrating an exemplary configuration of a user terminal. Although the configuration of the mobile terminal 50 will be discussed here for purposes of convenience, the same configuration is used for the PC terminal 70. The mobile terminal 50 is provided with a terminal communication module 51, a terminal control module 52, a user interface 53, and a terminal memory 54.

The terminal communication module 51 receives application programs downloaded from the server 10 and information of various types transmitted from the server 10. In addition, information of various types is transmitted to the server 10 in response to user input operations received through a user interface 53.

The terminal control module 52 receives user instructions from the user interface 53 and, while accessing the terminal memory 54, controls the installation of the application, controls the execution of the application, and so on.

The user interface 53 includes a screen interface for displaying various screens to the user, such as screens for messages or content viewing screens, speakers for outputting audio, and an input interface for receiving input from the user, such as a keyboard, a touchscreen panel, or the like. The user interface 53 receives selection operations or various types of information input operations from the user and passes them on to the terminal control module 52.

When an application is installed, the terminal memory 54 is used for storing the application program downloaded from the application-providing platform. In addition, it stores information of various types received by the terminal communication module 51 from the server 10, as well as user identification information (user IDs), and so forth, used by the application.

For example, after the terminal control module 52 receives a user operation through the user interface 53 and launches the game application, the game runs while the terminal communication module 51 communicates with the server 10 over the network 60. When an instruction is received from the user through the user interface 53 while the application is running, the terminal control module 52 can transmit an invitation request, which is intended to invite an invitee user to join said service, to the server 10 through the terminal communication module 51, and can acquire an invitation image, which will be described below.

In response to the user's instruction, the terminal control module 52 can create an invitation message including the acquired invitation image and can transmit it to the terminal of the invitee user. Here, the invitee user terminal uses a link indicated in the invitation message to access the server 10 and download the application. Furthermore, the registration procedure for the service associated with the application is completed in a simple and easy manner by transmitting the invitation image attached to the invitation message to the server 10. In accordance with this aspect, motivation to register with the service can be enhanced because the invitee user terminal can easily complete the registration procedure without being required to perform the conventional painstaking procedures involving entering multiple alphanumeric characters.

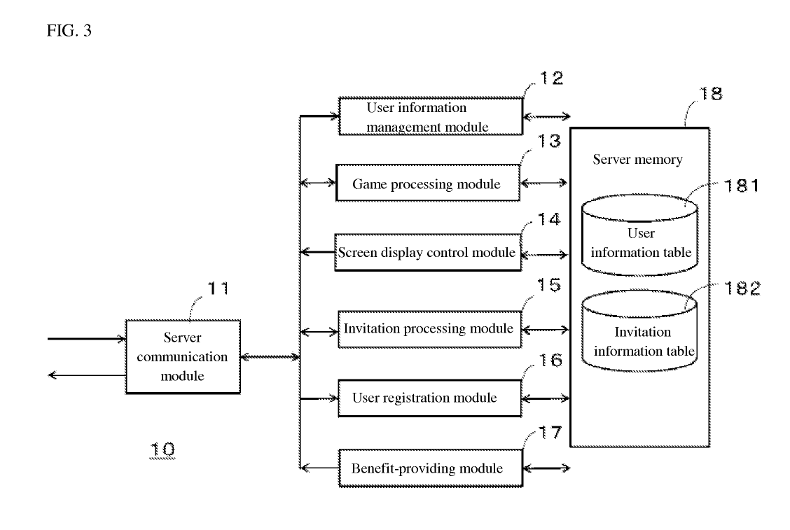

FIG. 3 is a diagram illustrating an exemplary configuration of the server 10 of FIG. 1. This server 10 includes a server communication module 11, a user information management module 12, a game processing module 13, a screen display control module 14, an invitation processing module 15, a user registration module 16, a benefit-providing module 17, and a server memory 18. The server memory 18 stores a user information table 181 and an invitation information table 182.

The server communication module 11 receives a signal from a user terminal, performs predetermined demodulation processing, and sends the demodulated signal to the user information management module 12, game processing module 13, screen display control module 14, invitation processing module 15, user registration module 16, and so forth.

In addition, the server communication module 11 receives instructions from the game processing module 13, screen display control module 14, invitation processing module 15, benefit-providing module 17, and so forth, performs modulation processing on predetermined data, and transmits it to the user terminal. The term “predetermined data” includes, for example, images relating to the game, or information and the like relating to invitation images or benefits.

It should be noted that conventional modulation/demodulation technology may be employed for modulation/demodulation processing in the server communication module 11 and, as will be appreciated by those skilled in the art, the present invention is also applicable to this aspect.

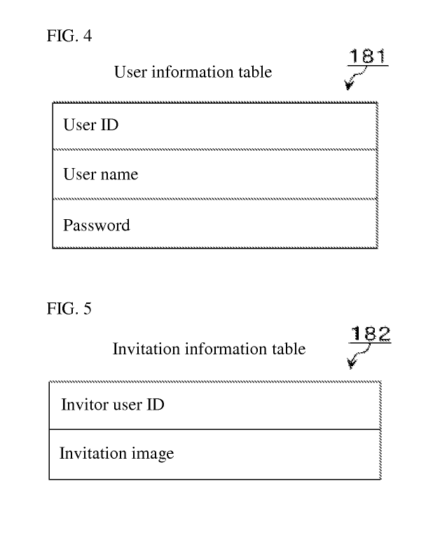

The user information management module 12 manages information relating to the users registered in the system 100 in the user information table 181 of the server memory 18. For example, as shown in FIG. 4, the user information table 181 includes a user ID, a user name, and a password. Information on these users is referenced in the game processing module 13 and the like.

Upon receiving a request to start a game that can be executed by the system 100 from the user terminal through the server communication module 11, the game processing module 13 starts the game and manages the progress of the game. In addition, as the game progresses, the game processing module 13 accesses user information stored in the server memory 18 and executes predetermined processing.

The screen display control module 14 exercises control to display predetermined images on the screen of the user terminal in accordance with the progress of the game or based on instructions from the game processing module 13. When the game application is launched for the first time, a user registration screen is displayed on the screen of the user terminal.

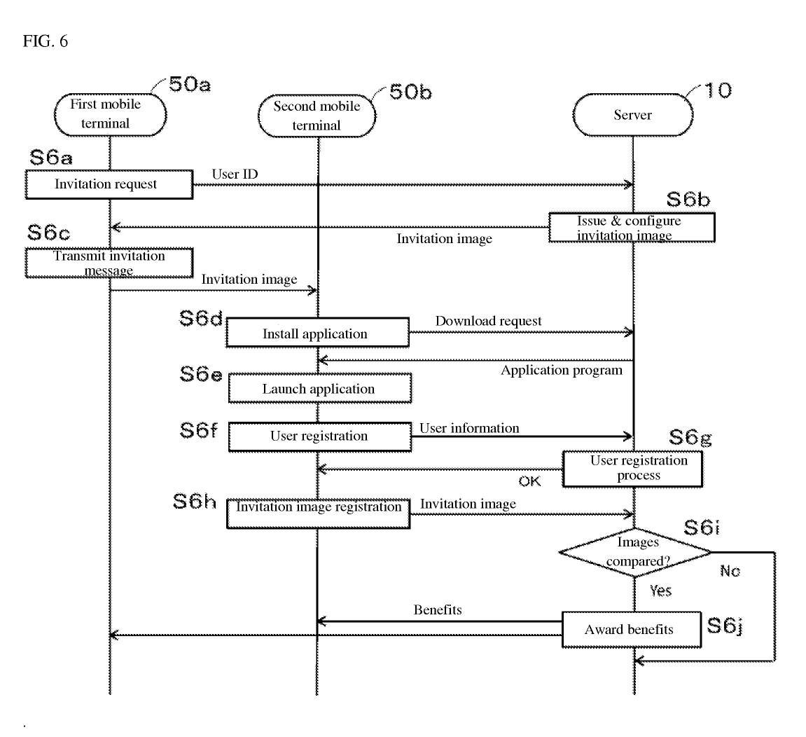

The invitation processing module 15 receives the invitation request transmitted from the terminal of the invitor user of said service through the server communication module 11, issues an invitation image for said service, and transmits it to the terminal of the invitor user. The above-mentioned issued invitation image is stored in the invitation information table 182 in the server memory 18 along with the identification information (invitor user ID) and the like of the invitor user, for example, as shown in FIG. 5. In addition to information that indicates the service, the invitation image can include advertising information, an overview of the service, and so on.

It should be noted that the phrase “in addition to information that indicates the service, . . . can include advertising information, an overview of the service, and so on” refers to the fact that the name of the service associated with the benefits and invitation application, as well as advertisements or UUIDs and other bar-code information, may be superimposed on the invitation image in a form recognizable as images or characters, and, in addition, may be electronically superimposed thereon using electronic watermarking techniques or the like. In accordance with such an aspect, verification is made possible even if the invitation image is subjected to resizing or other binary conversions when sending e-mail. In addition, as a result of incorporating a bar-code, a two-dimensional code, or other bar-code information in the invitation image, a proper registration procedure can be implemented in a simple and easy manner based on image verification. It should be noted that, in addition to increasing the visibility of the user when searching for the invitation image stored in the user terminal, incorporating advertisements into an invitation image makes it possible to issue invitations on behalf of a service that attract users through advertisements, as compared to conventional invitation codes that are based on impersonal text data. According to this aspect, security is improved because login attempts by third parties with conventional character string-based registration IDs (e.g., brute force attacks involving the detection of registration IDs in a round-robin manner) are made more difficult. The level of security can be raised because it is extremely difficult to execute a brute force attack on information superimposed on images. In addition, as far as the invitation image is concerned, a common image may be used throughout the entire service, or different images may be issued for each invitor user.

For example, when the application is launched for the first time, the user registration module 16 displays a user registration screen, or the like, on the screen of the user terminal and carries out user registration processing based on the input user information.

When the invitee user is registered in the user registration module 16, the benefit-providing module 17 compares the invitation image uploaded from the terminal of the invitee user with the invitation images stored in the invitation information table 182 and awards benefits to the invitor user and/or to the invitee user based on the result of this comparison. The benefits include, for example, in-game currency, items, points, or other gifts that can be used in other services provided by the system 10. It should be noted that, in order to further enhance security, processing intended for identity confirmation, for example, user ID verification, password verification, and verification of registration status in other services provided by the same server 10 may be performed in addition to the uploading and verification of the invitation image.

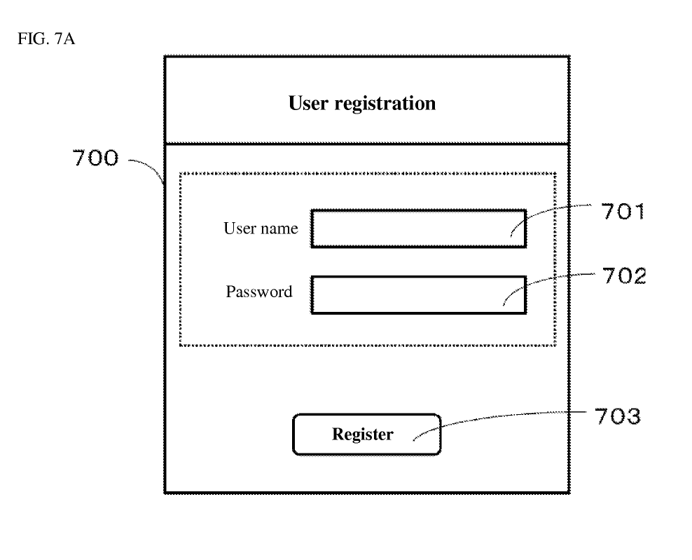

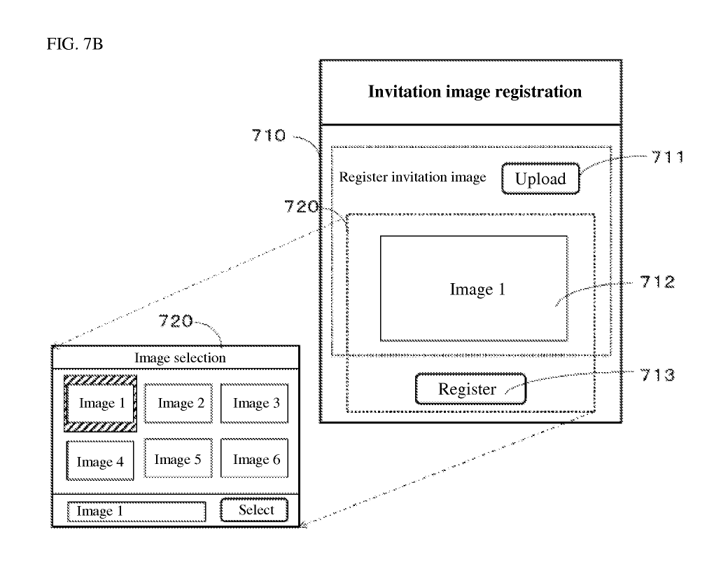

Next, the system according to Embodiment 1 will be described with reference to FIG. 6 and FIG. 7. FIG. 6 is a sequence diagram illustrating the processing procedure of the system according to Embodiment 1. Here, the discussion describes an example in which the user (invitor user) of a first mobile terminal 50a invites the user (invitee user) of a second mobile terminal 50b to a game service.

During the execution of the game service, the first mobile terminal 50a transmits an invitation request including a user ID to the server 10 in response to an operation performed by the invitor user (Step S6a). Upon receiving this invitation request, the invitation processing module 15 of the server 10 issues an invitation image for the invitor user, configures it along with the invitor user ID in the invitation information table 182, and transmits the invitation image to the first mobile terminal 50a (Step S6b).

In order to urge the invitee user to install the application program of said game service, the invitor user uses e-mail, SNS, or the like, to transmit an invitation message including the invitation image from the first mobile terminal 50a to the second mobile terminal 50b (Step S6c). Instead of transmitting, the second mobile terminal 50b may be directed to acquire the invitation image using recordable electronic media or network cloud storage. Upon receiving this invitation message, the invitee user installs the application program of said game service on the second mobile terminal 50b (Step S6d). For example, a download request is transmitted via an application download screen provided by the application-providing platform and the application program is received.

The invitee user launches the application installed on the second mobile terminal 50b (Step She) and user information is entered on the user registration screen and transmitted to the server 10 (Step S6f).

FIG. 7A illustrates an example of the user registration screen. The user registration screen 700 includes a user name entry field 701, a password entry field 702, and a register button 703. The user name entry field 701 and password entry field 702 can be configured for a combination of numerals, characters, and the like. When the invitee user presses the register button 703, the second mobile terminal 50b transmits the user name and password entered in the user name entry field 701 and password entry field 702 to the server 10.

The user registration module 16 of the server 10 receives the user name and password transmitted from the second mobile terminal 50b and performs user registration processing (Step S6g). For example, the user registration module 16 issues a new user ID and stores the user name and password in the user information table 181 in association with the issued user ID.

When the user registration procedure is complete, an invitation image registration screen is displayed on the second mobile terminal 50b (Step S6h). FIG. 7B illustrates an example of the invitation image registration screen. The invitation image registration screen 710 includes an upload button 711, an invitation image display field 712, and a register button 713. When the upload button 711 is pressed, the image selection screen 720 indicated by the dashed line is displayed superimposed on the invitation image registration screen 710, thereby enabling selection of the invitation image. The selected invitation image (here, Image 1) is displayed in the invitation image display field 712. When the invitee user presses the register button 713, the second mobile terminal 50b transmits the above-mentioned selected invitation image to the server 10. It should be noted that the user registration screen 700 and invitation image registration screen 710 may be configured to be on a single screen so that the user information and invitation image may be entered at the same time and be transmitted together to the server 10.

The benefit-providing module 17 of the server 10 compares the invitation image uploaded from the second mobile terminal 50b with the invitation images configured in the invitation information table 182 (Step S6i). If an invitation image matching the uploaded invitation image is discovered in the invitation information table 182 based on this comparison, the invitor user is identified, and the benefit-providing module 17 awards benefits to the invitee user and the invitor user identified based on the result of the comparison (Step S6j).

Here, the method of comparison of the invitation images in Step S6i will be described with reference to the following working examples.

### Working Example 1

In Working Example 1, the benefit-providing module 17 compares the binary data of the invitation image uploaded from the second mobile terminal 50b of the invitee user with that of the invitation image configured in the invitation processing module 15. The comparison of the binary data ensures a correct determination as to whether or not the image data is identical and makes it possible to distinguish invitation images, and so forth, that have undergone processing.

### Working Example 2

In Working Example 2, the benefit-providing module 17 compares a hash value calculated from the invitation image uploaded from the second mobile terminal 50b of the invitee user with hash values calculated from the invitation image configured in the invitation processing module 15. Security can be enhanced because it is difficult to forge images having the same hash values.

### Working Example 3

In Working Example 3, the invitation image contains a bar-code, a QR code (registered trademark), or another two-dimensional code, or the like, obtained by converting predetermined information, and the benefit-providing module 17 compares information read from the invitation image uploaded from the second mobile terminal 50b of the invitee user with information read from the invitation image configured in the invitation processing module 15. The incorporation of predetermined information into an ID code, such as a bar-code, a two-dimensional code, or the like, facilitates image comparison. Furthermore, as a result of incorporating an invitor user ID into a bar-code, a two-dimensional code, or the like, the invitor user ID can be readily identified by comparing images, and the invitor user ID can be omitted from the invitation information table 182.

As described above, in accordance with Embodiment 1, the registration procedure can be completed simply by selecting and uploading an invitation image, which makes it possible do away with manual entry of invitation IDs and allows for simple and easy registration.

In addition, if preventing the leakage of invitation IDs is desired, such as during pre-registration, the use of image data instead of invitation IDs makes it difficult to generate identical images, which can enhance security.

In addition, since the invitation image can include, for example, advertising information or information representing said service, it becomes possible to issue invitations on behalf of the service that attract users through advertisements, as compared to conventional invitation IDs that are based on impersonal text data.

### Embodiment 2

While in Embodiment 1 the invitation image was issued on the server side, in Embodiment 2, an image held in the terminal of the invitor user is used as the invitation image. It should be noted that since the configuration of the system and apparatus is similar to the above-described Embodiment 1, the description will refer to the above-mentioned FIG. 1 through FIG. 3, and descriptions duplicating Embodiment 1 will be omitted.

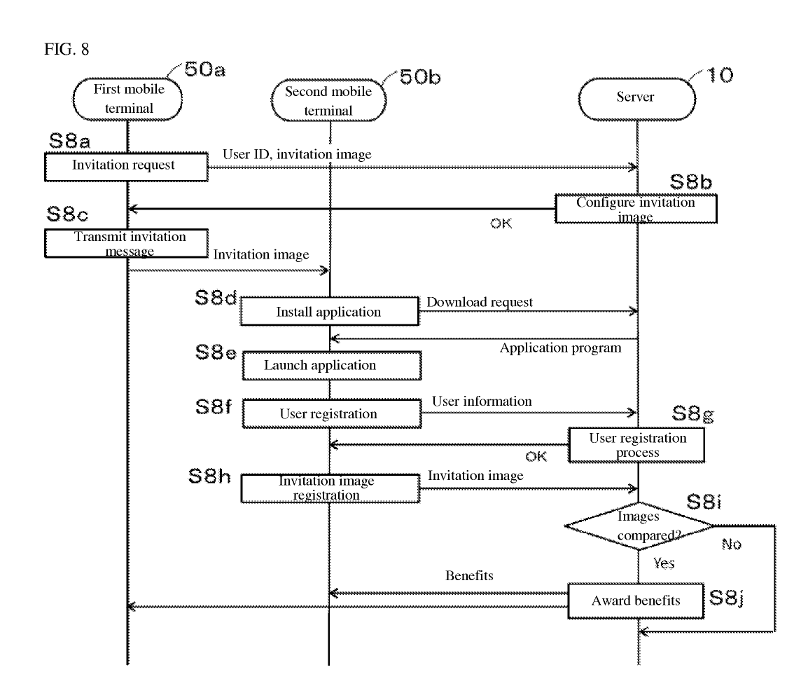

The operation of the system according to Embodiment 2 will now be described. FIG. 8 is a sequence diagram illustrating the processing procedure of the system according to Embodiment 2. The procedure will be explained for a case in which, in the same manner as in the above-described Embodiment 1, the user (invitor user) of the first mobile terminal 50a invites the user (invitee user) of the second mobile terminal 50b to join the game service.

During the execution of the game service, the first mobile terminal 50a transmits an invitation request including a user ID and an invitation image to the server 10 in response to an operation performed by the invitor user (Step S8a). Images held in the first mobile terminal 50a can be selected in an arbitrary manner as the invitation image. Upon receiving this invitation request, the invitation processing module 15 of the server 10 configures the invitation image selected by the invitor user, along with the invitor user ID, in the invitation information table 182 (Step S8b).

In order to urge the invitee user to install the application program of said game service, the invitor user uses e-mail, SNS, or the like, to transmit an invitation message including the invitation image from the first mobile terminal 50a to the second mobile terminal 50b (Step S8c). Upon receiving this invitation message, the invitee user installs the application program of said game service on the second mobile terminal 50b (Step S8d). For example, a download request is transmitted via an application download screen provided by the application-providing platform and the application program is received.

The invitee user launches the application installed on the second mobile terminal 50b (Step S8e), enters user information on a user registration screen, such as the one illustrated in the above-described FIG. 7A, and transmits it to the server 10 (Step S8f). The user registration module 16 of the server 10 receives the user name and password transmitted from the second mobile terminal 50b and performs user registration processing (Step S8g).

When the user registration procedure is complete, an invitation image registration screen, such as the one shown in the above-described FIG. 7B, is displayed on the second mobile terminal 50b. When the invitee user selects an invitation image on this invitation image registration screen, the second mobile terminal 50b uploads the selected invitation image to the server 10 (Step S8h).

The benefit-providing module 17 of the server 10 compares the invitation image uploaded from the second mobile terminal 50b with the invitation images configured in the invitation information table 182 (Step S8i). If an invitation image matching the uploaded invitation image is discovered in the invitation information table 182 based on this comparison, the invitor user is identified, and the benefit-providing module 17 awards benefits to the invitee user and the invitor user identified based on the result of the comparison (Step S8j).

As described above, Embodiment 2 produces effects that are similar to the above-described Embodiment 1, and, in addition, the use of an image belonging to the invitor user as the invitation image makes it easier to invite the invitee user to the service.

The present invention has been described above with reference to Embodiments. The present invention is not limited to the above-described Embodiments or the content of the working examples, and can be practiced with various modifications within the scope of the present invention. The above-described Embodiments are illustrative, and it will be appreciated by those skilled in the art that numerous variations thereof are possible based on combining the constituent elements and processing procedures, and that such variations also fall within the scope of the present invention.

### DESCRIPTION OF THE REFERENCE NUMERALS

100 System
10 Server
40 Base stations
40a First base station
40b Second base station
40c Third base station
50 Mobile terminals
50a First mobile terminal
50b Second mobile terminal
50c Third mobile terminal
60 Network
70 PC terminal
11 Server communication module
12 User information management module
13 Game processing module
14 Screen display control module
15 Invitation processing module
16 User registration module
17 Benefit-providing module
18 Server memory
181 User information table
182 Invitation information table
51 Terminal communication module
52 Terminal control module
53 User interface
54 Terminal memory

1. A server device that provides a predetermined service to a user terminal over a network, wherein the server device is furnished with:
an invitation processing module that configures invitation content information in response to an invitation request from a terminal of an invitor user of the service; and
a benefit-providing module that compares content information uploaded from an invitee user's terminal with content information configured by the invitation processing module when the invitee user invited by the invitor user registers with the service, and awards benefits to the invitor user and/or the invitee user based on the result of this comparison.

2. The server device according to claim 1, wherein the benefit-providing module presents a registration screen including an upload button to the terminal of the invitee user.

3. The server device according to claim 1, wherein the invitation processing module configures the content information held in the terminal of the invitor user as the invitation content information.

4. The server device according to claim 1, wherein the benefit-providing module compares the binary data of the content information uploaded from the terminal of the invitee user with that of the content information configured in the invitation processing module.

5. The server device according to claim 1, wherein the benefit-providing module compares the hash values of the content information uploaded from the terminal of the invitee user with those of the content information configured in the invitation processing module.

6. The server device according to claim 1, wherein the content information is an image including an ID code obtained by converting predetermined information, and the benefit-providing module compares information read from the content information uploaded from the terminal of the invitee user with information read from the content information configured in the invitation processing module.

7. A non-transitory computer readable medium having machine-executable instructions with which a computer having a storage and a hardware processor connected via a network to a user terminal device operate in a server device for providing predetermined services to user terminals over a network, said machine-executable instructions comprising:
an invitation process, which is used to configure invitation content information in response to an invitation request from the terminal of an invitor user of the service, and
a benefit provision process, during which content information uploaded from the terminal of an invitee user and content information configured during the invitation process are compared when the invitee user invited by the invitor user registers with the service and benefits are awarded to the invitor user and/or in the invitee user based on the result of this comparison.

8. A system having a server device providing predetermined services and user terminals connected to the server device over a network, wherein the system is furnished with:
means for transmitting an invitation request from the terminal of an invitor user of the service to the server device;
means for configuring invitation content information in the server device in response to the invitation request;
means for transmitting the content information to the terminal of an invitee user of the service; and
means for comparing content information uploaded from the terminal of the invitee user to the server device and content information configured in the server device when the invitee user registers with the service, and awarding benefits to the invitor user and/or invitee user based on the result of this comparison.
